(19) United States
(12) Patent Application Publication
(10) Pub. No.: US 2025/0217787 A1
(43) Pub. Date: Jul. 3, 2025

(54) ZERO-FRICTION EXIT EXPERIENCE VIA FRONTEND COMPUTER VISION

(71) Applicant: Walmart Apollo, LLC, Bentonville, AR (US)

(72) Inventors: Feiyun Zhu, Plano, TX (US); Lingfeng Zhang, Flower Mound, TX (US); Wei Wang, Dallas, TX (US); Yanmei Jin, Dallas, TX (US); William Craig Robinson, Centerton, AR (US); Colin Grant Mitchell, Wills Point, TX (US); Huanyu Zang, Dallas, TX (US); Zhaoliang Duan, Frisco, TX (US); Mingquan Yuan, Flower Mound, TX (US); Michael Alvin Schubert, Jr., Sulphur Springs, AR (US)

(21) Appl. No.: 18/990,189

(22) Filed: Dec. 20, 2024

Related U.S. Application Data
(60) Provisional application No. 63/616,362, filed on Dec. 29, 2023.

(51) Int. Cl. G06Q 20/20; G06T 7/20; G06T 7/50; G06V 10/25; G06V 20/52

(52) U.S. Cl. CPC G06Q 20/208; G06T 7/20; G06T 7/50; G06V 10/25; G06V 20/52; G06T 2207/20132; G06V 2201/07

(57) ABSTRACT

Examples provide a system and method for identifying unscanned items in real-time during a current transaction using computer vision object detection and recognition models. Images of a checkout area are received from camera(s) situated near the point-of-sale (POS). An object detection and recognition model analyze image data to identify items in a cart and/or on the POS conveyor belt. An item identifier (ID) is predicted for each identified item. As each item is scanned at the POS, the scanned item IDs are mapped to the identified item IDs. When a ready-to-pay signal is received, any identified items which fail to map to a scanned item are identified as unscanned items. A notification is sent to a user interface (UI) device associated with the POS. The notification includes an image of each unscanned item and an instruction to scan the items which were inadvertently unscanned prior to completion of the transaction.

### BACKGROUND

During transactions in retail facilities, items being purchased by customers are scanned via a scanning device at a point-of-sale (POS), such as a staffed checkout or a self-checkout (SCO). As each item is scanned, an item identifier (ID), such as a universal product code (UPC), is added to a list of scanned items which are ultimately included in a purchase receipt when the transaction is complete. However, in some transactions, one or more items may inadvertently fail to be scanned, resulting in shrink. In some cases, items in a customer's cart may be randomly selected and scanned at a store exit to verify whether those randomly selected items were scanned and included in the final purchase receipt. However, this is a time consuming and inefficient process, as only a few items are typically checked while the majority of the items in the customer's cart remain unchecked. Moreover, this procedure results in increased friction at store exit for customers.

### SUMMARY

Some examples provide a system and method for frontend unscanned item identification. Images of a selected cart and a plurality of items associated with the selected cart are obtained. The plurality of items associated with the selected cart are identified by a detection and recognition model. An item identifier (ID) associated with each item in the plurality of items is predicted. A set of identified items includes a plurality of item IDs associated with the plurality of items is generated. Item scan data is obtained from a point-of-sale (POS) device in real-time as each item is scanned. The item scan data includes an item ID associated with each item scanned at the POS device during a current transaction. A set of scanned items includes an item ID for each scanned item associated with the item scan data received from the POS device. Each scanned item ID is mapped to an identified item ID in the set of identified items. Upon receiving a scan complete signal from the POS device indicating a user is ready to complete the transaction, a set of unscanned items is identified based on mapping of the set of identified items to the set of scanned items. An unscanned item is an item having an item ID in the set of identified items that fails to map to a corresponding item ID in the set of scanned items. A notification is presented to a user interface device associated with the POS device prior to completion of the current transaction. The notification includes an identification of each item in the set of unscanned items and/or an image of each unscanned item. A user is instructed to scan each item in the set of unscanned items.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for frontend identification of unscanned items in real-time during a current transaction.

FIG. 2 is an exemplary block diagram illustrating a retail environment including a POS device and a set of cameras for capturing data used during frontend identification of unscanned items.

FIG. 3 is an exemplary block diagram illustrating an item scan manager for frontend identification of unscanned items.

FIG. 4 is an exemplary flow chart illustrating operation of the computing device to identify unscanned items in real-time during a current transaction.

FIG. 5 is an exemplary flow chart illustrating operation of the computing device to generate a list of scanned items and a list of identified items with predicted item identifiers (IDs) for use in generating an unscanned items notification for a user.

FIG. 6 is an exemplary flow chart illustrating operation of the computing device to notify a user of unscanned items in real-time during a current transaction.

FIG. 7 is an exemplary image showing a top view and a side view of a selected cart and a conveyor including a plurality of items at a staffed checkout.

FIG. 8 is an exemplary image showing a top view and a side view of a selected cart at a self-checkout (SCO).

FIG. 9 is an exemplary image showing a top view of a selected cart, a conveyor device and a receipt associated with a transaction.

FIG. 10 is an exemplary image of a user interface (UI) associated with a POS device for displaying an unscanned items notification to a user.

FIG. 11 is an exemplary table illustrating performance of the frontend CV system over a receipt check system.

FIG. 12 is an exemplary system architecture for frontend identification of unscanned items.

FIG. 13 is an exemplary screenshot of a receipt check screen displayed via a UI device.

FIG. 14 is an exemplary screenshot of a scan items notification including a cart image with instructions to scan a sample of the items in the cart associated with the image.

FIG. 15 is an exemplary screenshot of a scan items notification including a cart image with a side view of a cart.

FIG. 16 is an exemplary screenshot of a scan items notification including a cart image with highlighted items for scanning by a user prior to customer exit.

FIG. 17 is an exemplary screenshot of an unscanned items notification displayed via a UI device.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Shrink is an issue troubling retailers worldwide, resulting in over $61B in lost profit every year. At some stores, missed item scans at exit alone can result in millions in shrink annually. Some stores attempt to reduce shrink by stopping customers as they exit the store and scanning a few random items in their cart. However, this approach creates additional friction for customers due to long wait times and an additional step before leaving the store. It makes it difficult for customers to pay for items that were missed since it cannot be done at exit. It also limits the amount of shrink captured because only a small sample size of items from each cart are scanned and verified. This is inefficient and unreliable method of reducing shrink due to unscanned items.

Referring to the figures, examples of the disclosure enable frontend identification of unscanned items. In some examples, when a user indicates they are ready to complete a purchase transaction, the system maps each scanned item to items identified using computer vision (CV) object detection and recognition models. If any item identified by the CV models fails to map to a scanned item, a notification is generated and presented to the user via a user interface device. This enables the user to scan missed items quickly and easily while the user is still at the point-of-sale (POS) device with minimal friction while reducing shrink resulting from unscanned items remaining at customer exit from the store.

In other embodiments, the system presents an image of each unscanned item to a user at a POS device in real-time during a current transaction via a UI. This enables the user to quickly identify and scan each unscanned item. This improves user efficiency via the UI interaction with increased user interaction performance.

The computing device operates in an unconventional manner by presenting a list of unscanned items to a user at a POS device in real-time during a current transaction before the transaction is completed, thereby enabling the user to quickly scan and pay for missed items during a single (current) transaction. This reduces system resources consumed by scanning random items and requires customers to start a new, second transaction operation to scan and pay for missed items after the first (original) transaction was already completed. Enabling missed items to be scanned during the same (original) transaction enables reduced processor usage, network bandwidth usage and memory usage consumed in completing an additional purchase transaction. Moreover, the computing device is used in an unconventional way and allows reduced number of unpaid items, improves customer experience, and improves overall efficiency of human users by eliminating the need to scan random items in a customer cart at exit.

The system further reduces human time and effort consumed scanning receipts and matching randomly scanned items to the receipts at exit, reducing queue lines of customers waiting to exit the store, as well as eliminating time spent starting another purchase transaction to scan and purchase missed items. The frontend identification of unscanned items further improves customer experience by saving customer time at exit and reducing friction for customers exiting the store.

In some examples, computer vision technology is used to capture images of customer carts and identify items within the cart. The system compares recognized items to the items scanned at the POS and/or recorded on the receipt. The system identifies potential shrink and notifies a user or cashier upstream right before the transaction is completed, sending the missed item alert to the tablet or other user interface (UI) at the checkout terminal. This enables the user to complete the scanning and payment of the identified missed items before the transaction is completed. With the frontend CV system, customers from staffed and unstaffed checkout lanes are not stopped at exit door for another check, reducing the extra step and saving a lot of friction for customers.

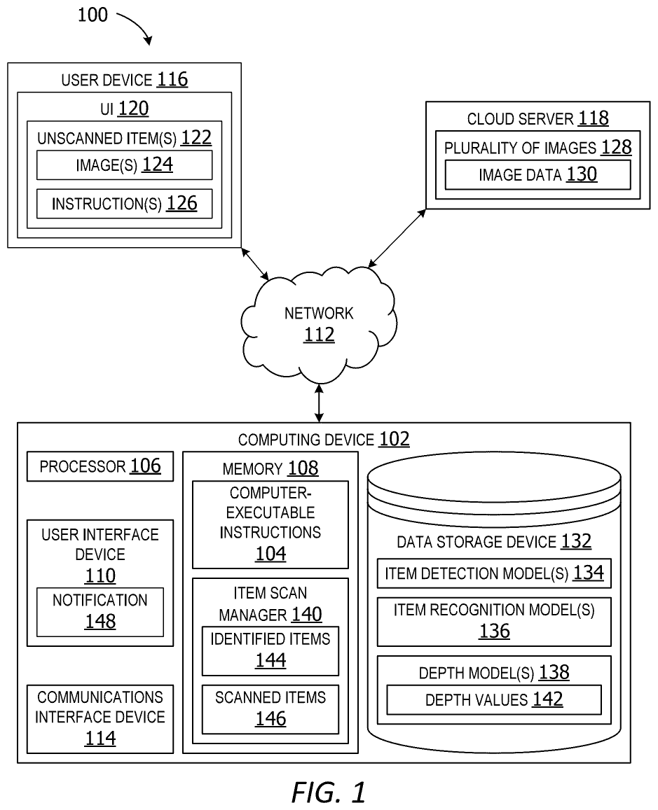

Referring again to FIG. 1, an exemplary block diagram illustrates a system 100 for frontend identification of unscanned items in real-time during a current transaction. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

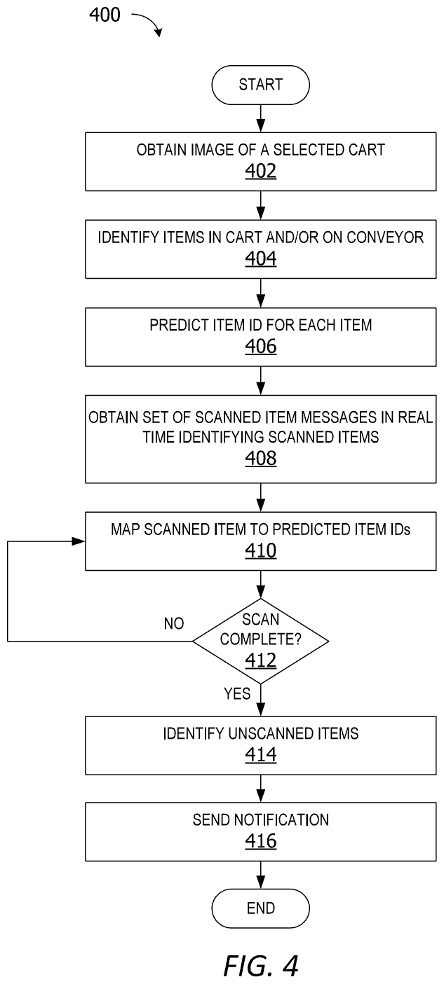

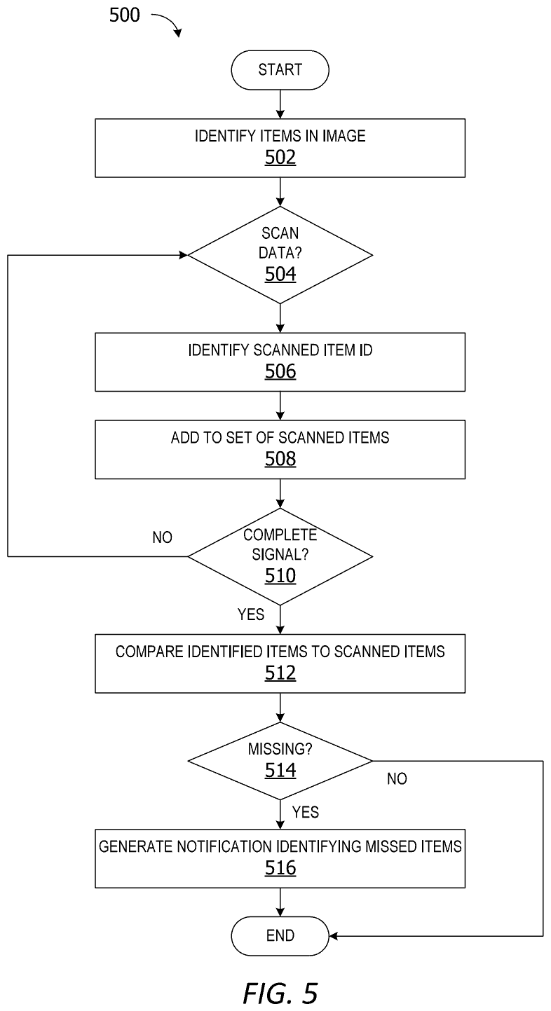

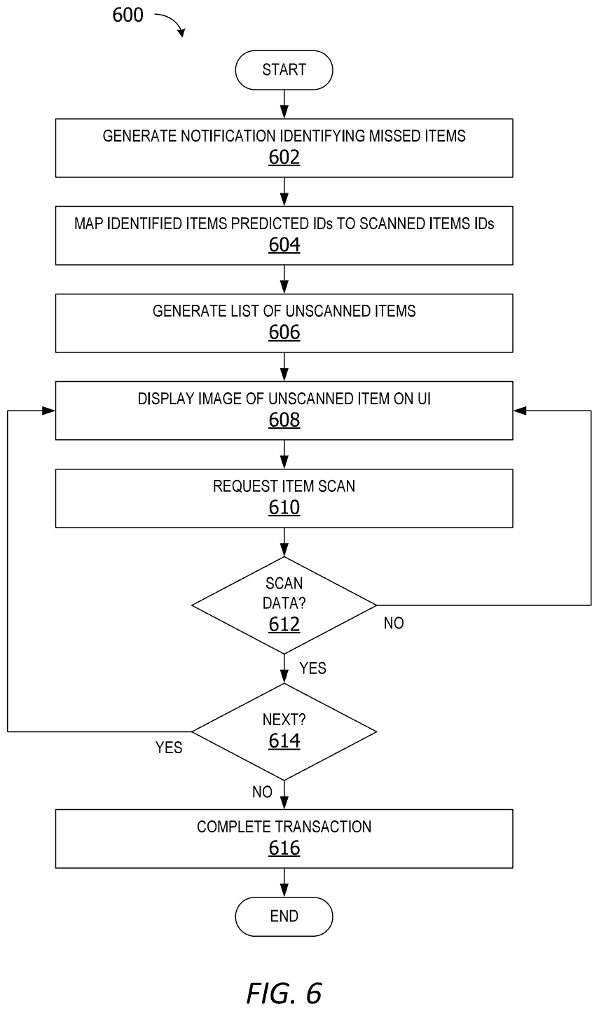

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 4, FIG. 5, and FIG. 6).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) 120 for displaying unscanned item notification data to a user, such as, but not limited to, an identification of a set of one or more scanned item(s) 122, one or more image(s) 124 of the unscanned items and/or one or more instruction(s) 126 to scan each of the unscanned item(s) 122. The UI 120 is a device for presenting data to a user, such as, but not limited to, the user interface device 110. In some examples, the UI 120 is a UI associated with a point-of-sale (POS) device.

In these embodiments, the image(s) 124 do not include images of users or other individuals within the retail facility. Any images having human users or other objects which are not of interest inadvertently included within the images are removed from the image(s) by cropping the images such that only objects of interest remain in the cropped images. Images of users or objects which are not of interest are deleted or otherwise discarded. The cropped images containing only the objects of interest, such as shopping carts, items in the shopping carts, and/or items on the POS device conveyor, are then analyzed to identify and label the objects of interest within the cropped images, such as, but not limited to, the image(s) 124.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers. In still other examples, the cloud server 118 includes a cloud storage for storing data, such as, but not limited to, a plurality of images 128 of a plurality of carts holding one or more items in a retail environment. The plurality of images 128, in this example, are digital images including image data 130, such as image metadata and/or detected item indicators.

The system 100 can optionally include a data storage device 132 for storing data, such as, but not limited to, one or more item detection model(s) 134, one or more item recognition model(s) 136, and/or one or more depth model(s) 138 for calculating depth values 142 associated with one or more objects in an image, such as shopping carts in proximity to a POS device. The one or more item detection model(s) 134 include pre-trained, computer vision (CV), deep learning item detection models.

The object detection model(s) 134 are trained to analyze one or more image(s) of a checkout area within a retail environment and identify shopping carts, items in shopping carts, and/or items on a conveyor belt associated with a POS device shown in the image(s). The detected items are enclosed within bounding boxes in the image(s). The images are cropped to isolate the selected shopping cart identified in the image. The image(s) of the shopping cart is cropped to isolate the one or more item(s) in the shopping cart. The image(s) of the conveyor is cropped to isolate any items detected on the conveyor which are part of the current transaction.

The item recognition model(s) 136 includes one or more trained, CV deep learning models trained to recognize the items detected by the item detection model(s) 134. The item recognition model(s) 136 predicts or infers an item ID for each recognized item. The item ID, in some examples, is a universal product code (UPC) associated with the identified item. For example, if the item detection model(s) 134 isolate an item in an image that is recognized as a brand “A” 24-pack of soft drinks, the item recognition model(s) 136 infers an item ID for the brand “A” 24-pack of soft drinks and associates that item ID with the image of the brand “A” 24-pack soft drinks. The item recognition model(s) are trained using labeled image data including images of thousands of items in a catalog of items stocked and/or offered for sale in the retail store.

The depth model(s) 138 includes one or more models trained to generate depth values 142 associated with one or more objects (items) in an image. In this example, the depth model(s) 138 determines a depth value for each shopping cart in an image. The depth values are used to identify a shopping cart which is closest in proximity to the POS device and therefore, predicted to be the shopping cart associated with the current transaction. Carts which are located too far away from the POS device (threshold depth/distance) are discarded or disregarded.

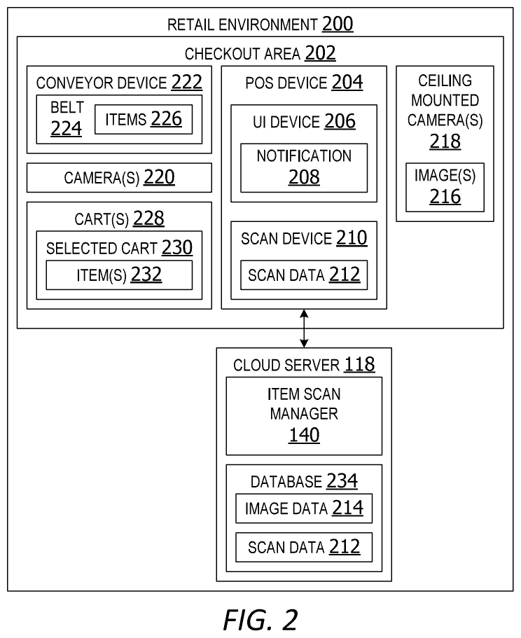

The data storage device 132 can include one or more different types of data storage devices, such as, for example, one or more rotating disks drives, one or more solid state drives (SSDs), and/or any other type of data storage device. The data storage device 132, in some non-limiting examples, includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 132 includes a database, such as, but not limited to, the database 234 in FIG. 2.

The data storage device 132, in this example, is included within the computing device 102, attached to the computing device, plugged into the computing device, or otherwise associated with the computing device 102. In other examples, the data storage device 132 includes a remote data storage accessed by the computing device via the network 112, such as a remote data storage device, a data storage in a remote data center, or a cloud storage.

The memory 108 in some examples stores one or more computer-executable components, such as, but not limited to, an item scan manager 140, that, when executed by the processor 106 of the computing device 102, obtains an image of a selected cart and a plurality of items associated with the selected cart. The item scan manager 140 identifies the plurality of items associated with the selected cart. The item scan manager 140 predicts an item ID associated with each item in the plurality of items. A set of identified items 144 includes a plurality of item IDs associated with the plurality of items is generated. The item scan manager 140 obtains item scan data in real time from the POS device. The item scan data includes item IDs associated with each item scanned at the POS device during a current transaction. A set of scanned items 146 includes an item ID for each scanned item associated with the item scan data received from the POS device. The item scan manager 140 maps each scanned item ID to an identified item ID in the set of identified items 144. The item scan manager 140 receives a scan complete signal from the POS device indicating a user is ready to pay for the set of scanned items. The scan complete signal may also be referred to as a ready-to-pay signal. The item scan manager 140 identifies a set of unscanned item(s) 122 based on mapping of the set of identified items to the set of scanned items. An unscanned item is an item having an item ID in the set of identified items that fails to map to a corresponding item ID in the set of scanned items. The item scan manager 140 generates a notification 148 including the item IDs of the unscanned items and/or images of the unscanned items. The item scan manager 140 sends the notification 148 to a user interface device for viewing by a user, such as, but not limited to, the user interface device 110 and/or the UI 120 of the user device 116.

The notification instructs the user to scan the unscanned items. In some examples, an image of each unscanned item is displayed one at a time with an instruction to scan the item. When the item is scanned, if there is another unscanned item, the image of the next unscanned item is presented to the user with another instruction to scan the next unscanned item. In other examples, the notification 148 includes an image of the shopping cart with bounding boxes highlighting each unscanned item in the image. This enables the user to view all the unscanned items at once and see the location of the items in the cart. In still other examples, a cropped image of each unscanned item is displayed on the UI for viewing by the user.

The item scan manager 140 in this example is implemented on the computing device 102. However, the embodiments are not limited to implementation of the item scan manager on a local computing device, such as a server. In other examples, the item scan manager is implemented on a cloud server, such as, but not limited to, the cloud server 118, as shown in FIG. 2 below.

FIG. 2 is an exemplary block diagram illustrating a retail environment 200 including a POS device 204 and a set of cameras 220 for capturing data used during frontend identification of unscanned items. The retail environment 200 is an environment including a retail facility, such as, but not limited to, a retail store, a warehouse and/or a distribution center storing and/or displaying items available for purchase or lease by customers. The retail environment includes an indoor area, outdoor area, and/or a partially enclosed area for storing and/or displaying items for retail sale. In this example, the retail environment 200 includes a checkout area 202.

The checkout area 202 is an area associated with a POS device 204 for completing a transaction to purchase one or more items. The checkout area 202 includes staffed checkout lanes and/or unstaffed, self-checkout (SCO) lanes. In this example, the POS device 204 includes a UI device 206 for displaying data to a user, such as, but not limited to, a UI 120 and/or the user interface device 110. Data displayed may include notification 208 in some examples.

The POS device 204 includes a scan device 210 for scanning item identifiers codes associated with items, such as, but not limited to, a universal product code (UPC), a radio frequency identifier (RFID) tag, matrix barcode, or any other type of identifier. The scan device generates scan data 212 associated with the scans of each item. As each item is scanned by the scan device 210, the POS device transmits the scan data for the scanned item to the item scan manager 140 via a network, such as, but not limited to, the network 112 in FIG. 1.

For example, if a user scans two items, a first message containing first scan data associated with scanning the first item is transmitted to the item scan manager 140. The item scan manager 140 identifies an item ID for the first scanned item based on the scan data in the first message. When the second item is scanned at the POS device, a second message containing different scan data associated with the second item UPC is transmitted to the item scan manager. The item scan manager 140 uses the second scan data to determine the item ID of the second item.

In this example, when the first item is scanned and the scan data is transmitted to the item scan manager, this constitutes a start signal triggering the item scan manager to begin analyzing image data 214 associated with the current ongoing transaction and identify items in the image(s) 216 generated by a set of cameras, including one or more ceiling mounted camera(s) 218 and/or one or more camera(s) 220 mounted on the POS device 204. The image(s) 216 include one or more top views (birds eye view) of the conveyor device 222. The conveyor device 22 includes a belt 224 having one or more items 226 resting on a surface of the belt. The image(s) also include one or more shopping cart(s) 228 near the POS device 204.

In this example, data such as the image data 214 and/or scan data 212 is stored on a database 234. The database 234 is any type of database, such as, but not limited to, a relational database.

The item scan manager 140 analyzes the image(s) 216 using a depth model to identify a selected cart 230 nearest to the POS device, such as but not limited to, the depth model(s) 138 in FIG. 1. The item scan manager uses object tracking to track the selected cart 230 through a sequence of images generated by the camera(s) 220 and/or the ceiling mounted camera(s) 218.

The item scan manager 140 detects and identifies one or more item(s) 232 in the selected cart 230 via one or more detection and recognition models, such as, but not limited to, the item detection model(s) 134 and/or the item recognition model(s) 136 in FIG. 1. In some examples, the POS device optionally includes a printer (not shown) for printing a receipt including a listing of all the scanned items when the transaction is completed.

In other examples, the POS device includes a processor and a memory for generating messages transmitted to the item scan manager 140, such as, but not limited to, the messages including the scan data (scanned item messages), a start signal sent when a first item is scanned at the beginning of a transaction, and/or a scanning complete (end) message when a user selects a ready-to-pay option via the POS device when the user is finished scanning items.

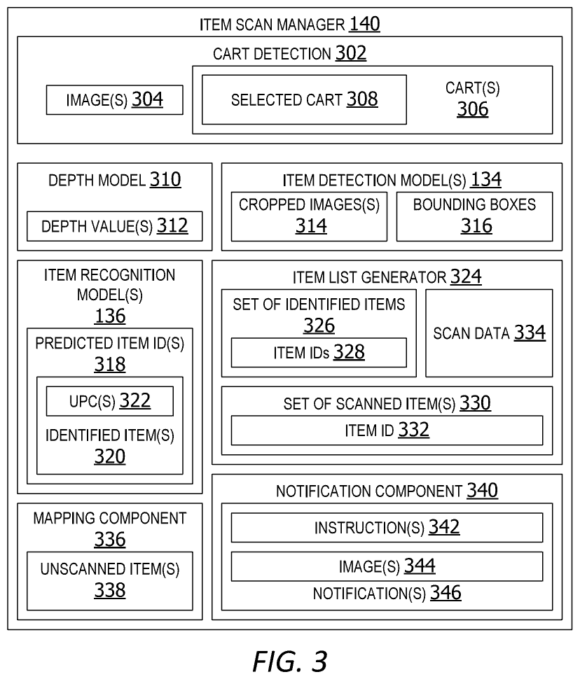

Referring to FIG. 3, an exemplary block diagram illustrating an item scan manager for frontend identification of unscanned items is shown. In some examples, a cart detection 302 obtains one or more image(s) 304 of one or more cart(s) 306. In this example, the cart detection 302 obtains between five and twenty images captured by a camera at a staffed checkout lane. However, the examples are not limited to using five to twenty images. The cart detection may utilize a single image, as well as two or more images of one or more carts. The cart detection 302 is a software component that employs a cart detection algorithm to isolate and extract the selected cart 308 and/or a conveyor belt area within the checkout area. Additionally, a depth model 310 estimates depth value(s) 312 for each cart in the image(s) view, enabling the system to accurately identify the selected cart corresponding to the ongoing transaction. The depth model 310 is a trained deep learning model, such as, but not limited to, the depth model(s) 138 in FIG. 1.

The item detection model(s) 134 applies an item detection algorithm to crop images of items present in the selected cart 308 and/or on the conveyor belt. This process enables precise localization of items within the captured images. The cropped image(s) 314 are isolated or highlighted by bounding boxes 316 enclosing the detected items in some examples.

The item recognition model(s) 136 apply two item recognition algorithms are utilized to infer the Universal Product Code (UPC) from the cropped item images. These algorithms facilitate accurate identification and recognition of items in the transaction. The item recognition model(s) generate predicted item IDs 318 for the identified item(s) 320. The identified items include items detected in the images that the item recognition model(s) recognize and infer an item ID. The item IDs, in this example, include one or more item UPC(s) 322.

An item list generator 324 generates a set of identified items 326 including the inferred or predicted item ID 328 for each item recognized by the item recognition model(s) 136. The set of identified items 326 may be referred to as a list of identified items. The item list generator generates a set of scanned item(s) 330 including the item ID 332 for each item scanned. The scanned items are identified using scan data 334 received from a POS device, such as, but not limited to, the POS device 204.

By leveraging the computer vision item detection model(s) 134 and the item recognition model(s) 136, in this example, the item scan manager 140 of the frontend CV system generates the set of identified items 326 by inferring from the image(s) 304. The set of identified items (inferred item list) is then compared with the set of scanned items, resulting in the prediction of two lists, a scanned item list including items which have been paid for or are about to be paid for and the unscanned (unpaid) item list (potential shrinkage items).

A mapping component 336 performs unscanned item detection to generate a set of one or more unscanned item(s) 338. In the event that the frontend CV system detects unscanned and/or unpaid items during a transaction, upon receiving the ‘ready to pay’ signal, a notification component 340 of the item scan manager 140 sends one or more notification(s) 346 to the tablet or UI device mounted next to the checkout monitor.

In other words, the item scan manager can send a single notification identifying all the unscanned items or the item scan manager can send a series of notifications in which each notification identifies a single unscanned item. After each unscanned item is scanned, the new scan data for the scanned item is received triggering the item scan manager to send the next notification identifying the next unscanned item that requires scanning. In this manner, the notifications enable the system to walk the user through the process of identifying each unscanned item one at a time and scanning it (adding it to the basket of scanned items).

The notification(s) 346 includes instruction(s) 342 to scan the unscanned item(s) 338 and/or image(s) 344 of the unscanned item(s) 338. In some embodiments, these notifications display red bounding boxes, one at a time, on the checkout image, effectively highlighting the unpaid items for further attention and resolution.

FIG. 4 is an exemplary flow chart illustrating operation of the computing device to identify unscanned items in real-time during a current transaction. The process 400 shown in FIG. 4 is performed by an item scan manager component, executing on a computing device, such as the computing device 102 or the user device 116 in FIG. 1.

The process begins by obtaining an image of a selected cart at 402. The selected cart is a cart associated with a current transaction, such as, but not limited to, a selected cart 230 in FIG. 2 and/or the selected cart 308 in FIG. 3. The item recognition model identifies items in the selected cart and/or on the conveyor associated with the POS device in the image at 404. The item recognition model predicts an item ID for each item at 406. The item scan manager receives a set of scanned item messages in real time identifying scanned items at 408. The scanned item messages are received from the POS device and/or the scanner device associated with the POS device, such as, but not limited to, the POS device 204 in FIG. 2. The item scan manager maps the scanned items to the predicted item IDs at 410. The item scan manager determines if the scanning is complete at 412. The item scan manager determines the scanning is complete when a ready-to-pay (scan complete) signal is received from the POS device. When scanning is complete, the item scan manager identifies unscanned items at 414 and sends a notification for a presentation to a user at 416. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

FIG. 5 is an exemplary flow chart illustrating operation of the computing device to generate a list of scanned items and a list of identified items with predicted item identifiers (IDs) for use in generating an unscanned items notification for a user. The process 500 shown in FIG. 5 is performed by an item scan manager component, executing on a computing device, such as the computing device 102 or the user device 116 in FIG. 1.

The process begins by identifying items in an image at 502. The items are identified by item detection models and/or item recognition models, such as, but not limited to, the item detection model(s) 134 and/or the item recognition model(s) 136. The item scan manager determines whether scan data associated with a scanned item is received from the POS device at 504. If yes, the item scan manager identifies the scanned item ID at 506. The scanned item ID is added to a set of scanned items at 508. A determination is made whether a scan complete (ready-to-pay) signal is received from the POS device at 510. If not, the process iteratively receives scan data as each item is scanned at the POS device. The scanned data is used to identify scanned item IDs and add those scanned item IDs to the set of scanned items until scanning is complete at 510.

The item scan manager compares the identified items to the scanned items at 512. A determination is made whether any identified items are missing from the set of scanned items at 514. If yes, a notification identifying the missed items is generated at 516. The notification is transmitted to a user scanning the items. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to notify a user of unscanned items in real-time during a current transaction. The process 600 shown in FIG. 6 is performed by an item scan manager component, executing on a computing device, such as the computing device 102 or the user device 116 in FIG. 1.

The process begins by receiving a scan complete signal at 602. In some examples, the scan complete signal is sent when a user selects a “ready to pay” option at the POS device. The item scan manager maps identified items predicted IDs to scanned item IDs at 604. The item scan manager generates a list of unscanned items based on the mapping at 606. The image of unscanned items is displayed via a UI at 608. A request to scan the unscanned item is displayed to the user at 610. The request is presented via the UI. A determination is made whether the scan data is received at 612. If yes, a determination is made whether a next unscanned item needs to be scanned at 614. If yes, the process iteratively executes operations 608 through 614 until all unscanned items are scanned or the unscanned items are removed from the customer's basket. If there are no remaining unscanned items, the transaction is completed at 616. The transaction is completed when the user pays for the scanned items and a receipt is issued to the user. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

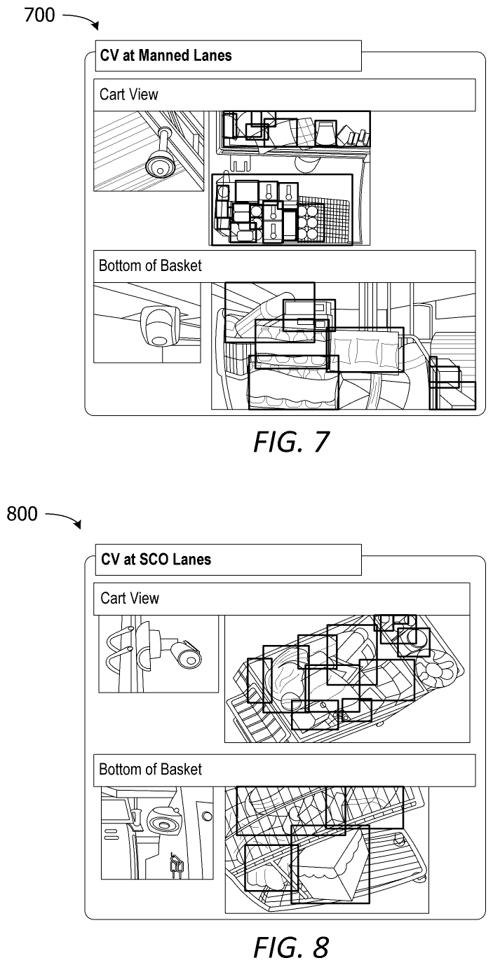

FIG. 7 is an exemplary image 700 showing a top view and a side view of a selected cart and a conveyor including a plurality of items at a staffed checkout. The selected cart in this example is enclosed in a bounding box. The items on the conveyor and inside the selected cart are also placed inside item detection bounding boxes. In this example, a camera is mounted to a ceiling above the checkout area and another camera is mounted to an underside of a portion of the POS device.

FIG. 8 is an exemplary image 800 showing a top view and a side view of a selected cart at a self-checkout (SCO). The image 800 includes bounding boxes enclosing individual items inside the selected shopping cart. In this example, a camera is mounted to a ceiling above the checkout area and another camera is mounted to a side of the POS device.

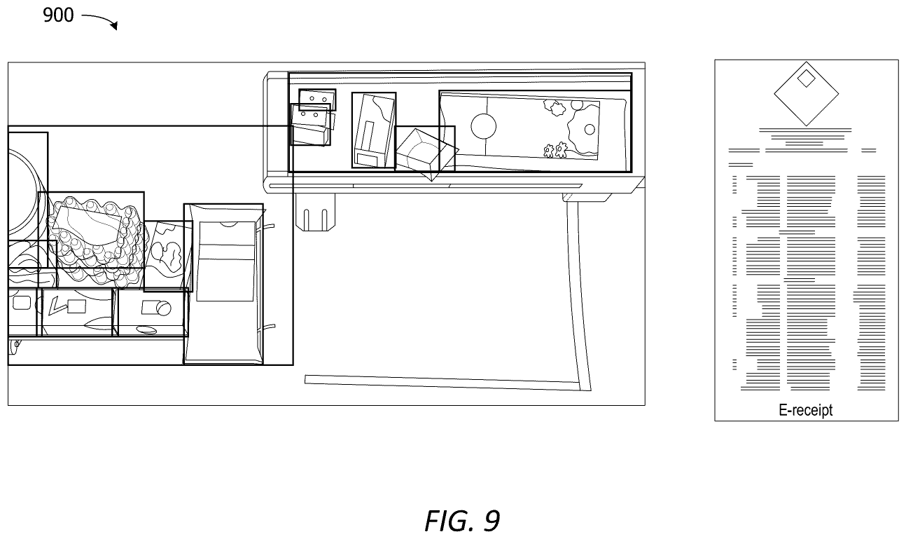

FIG. 9 is an exemplary image 900 showing a top view of a selected cart, a conveyor device and a receipt associated with a transaction. Bounding boxes are placed around the selected cart and around items on the cart and on the conveyor, belt associated with the POS device. In this example, the data fed into the frontend computer vision (CV) system consists of approximately 5-20 images capturing the transaction and the corresponding receipt.

In other examples, the system performs cart detection, item detection, and cart level depth estimation using one or more ML models, such as, but not limited to, a computer vision model. The system further performs recognition, classification, and verification of the items detected in the image data via the CV analysis of the image(s) of the cart(s). In one example, the computer vision model is a You Only Live Once Version Five (YOLOv.5) CV model.

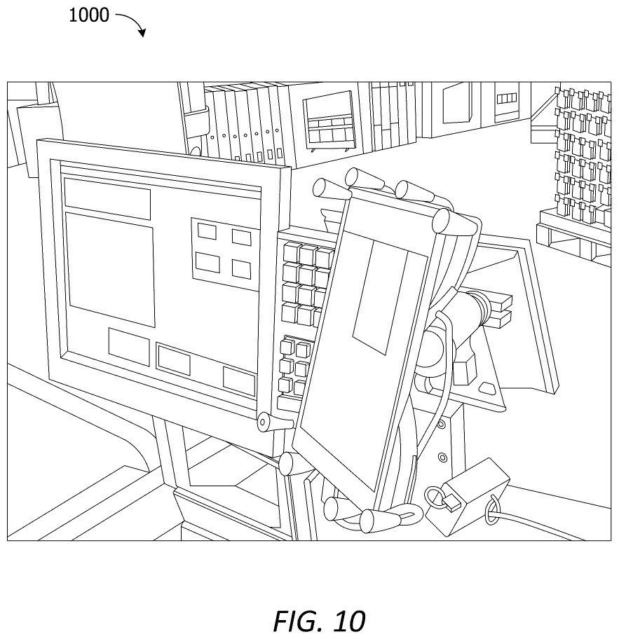

FIG. 10 is an exemplary image 1000 of a user interface (UI) associated with a POS device for displaying an unscanned items notification to a user. The notification(s), in this example, are presented to the user via the UI attached to the POS device. However, in other examples, the notification(s) are presented to the user via a UI on a separate user device that is not connected or otherwise associated with the POS device, such as, but not limited to, the user device 116 in FIG. 1.

In some embodiments, when the frontend computer vision (CV) system detects unpaid items during a transaction, upon receiving the ‘ready to pay’ signal, it will send notifications to the tablet mounted next to the checkout monitor. These notifications, in this example, display red bounding boxes, one at a time, on the checkout image, highlighting the unpaid items.

In this example, the POS device including a scanner for scanning items during a current transaction. As each item is scanned, scan data is transmitted to the item scan manager, such as, but not limited to, the item scan manager 140 on the computing device 102 in FIG. 1.

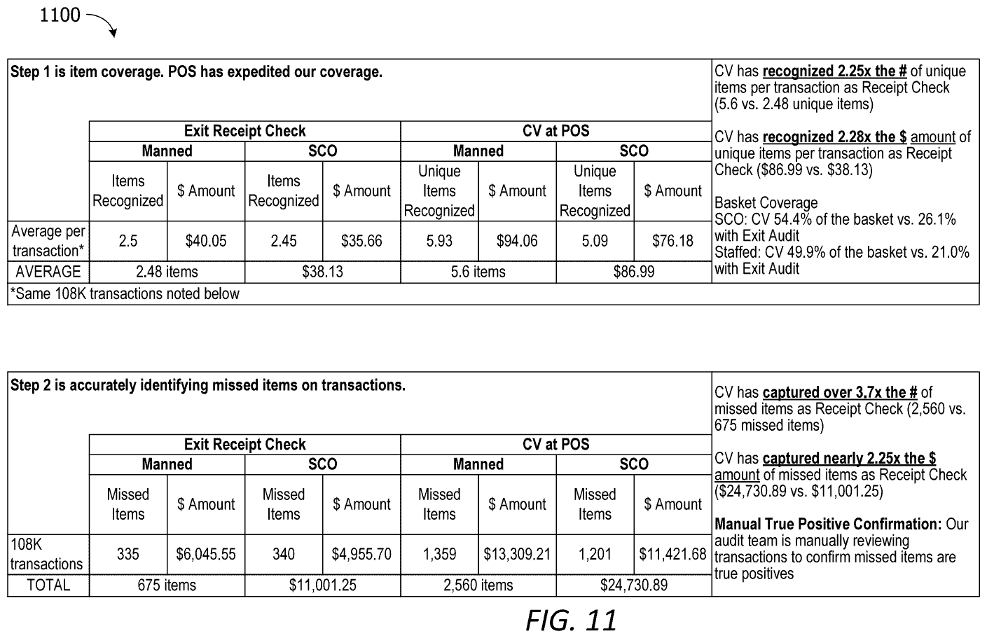

FIG. 11 is an exemplary table 1100 illustrating performance of the frontend CV system over a receipt check system. When comparing the performance of the frontend CV system and the receipt check, the results clearly demonstrate the superiority of the frontend CV system over the receipt check, yielding significantly better outcomes.

In this example, extensive analysis of 108,000 transactions reveals that the frontend CV system consistently delivers significantly superior results when compared to the receipt check method. The CV system has increased item coverage, where it has recognized 2.25 times the number of unique items per transaction as the manual receipt check method (5.6 vs. 2.48 unique items). The CV has recognized 2.28 times the dollar amount of unique items per transaction as the manual receipt check ($86.99 vs. $38.13). The CV system accurately detects unpaid items. The CV system has captured over 3.7 times the number of missed items as the manual receipt check method (2,560 vs. 675 missed items). The CV has captured 2.25 times the dollar amount of missed items as the manual receipt check method ($24,730.89 vs. $11,001.25).

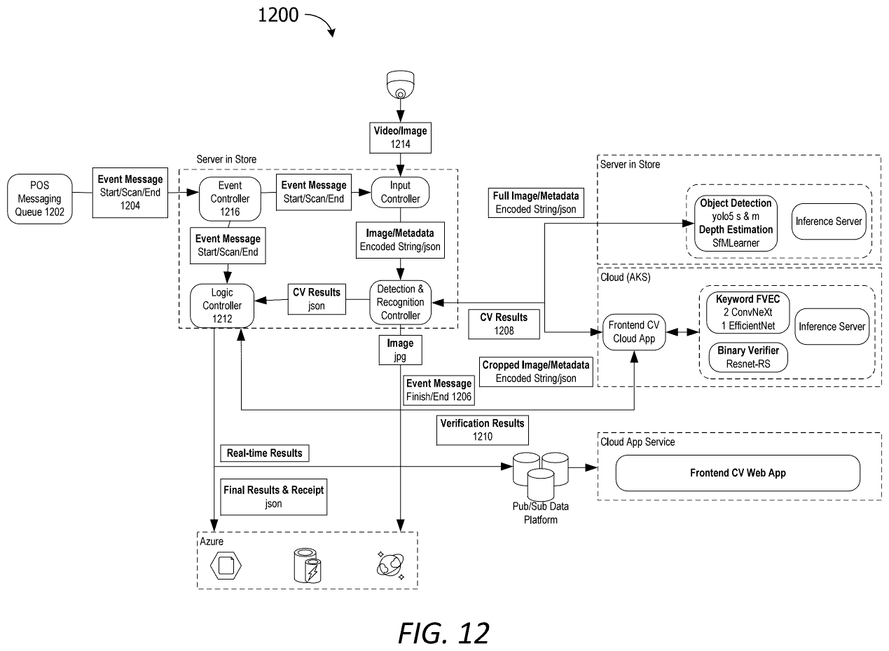

FIG. 12 is an exemplary system architecture 1200 for frontend identification of unscanned items. In this example, the POS sends a signal to start at 1202. The signal is a start/scan/end event message 1204. As each item is scanned, the analysis occurs in real-time. The final CV results 1208 and verification results 1210 are generated when a finish/end signal 1206 is received, such as when a ready to pay option is selected. The results are aggregated. The results are provided, in this example, in a JSON format.

In some examples, an alert is sent if any items remain unscanned. The logic controller 1212 listens for messages from the checkout machine. When it receives a start message, the system obtains (reads) input messages containing image data from cameras, such as the video/image 1214. The images are used for item detection and recognition inferences.

As each item is scanned, a new message is sent from the event controller 1216 to the logic controller 1212 in a continual stream of event messaging as the items are scanned in real-time. A final message that the customer is ready to pay triggers generation of the notification if any items remain unscanned. The notification is published to a UI for viewing by an associate or by the customer. If this is manned/staffed lane, the message goes to the cashier. If this is self-checkout, the message goes to the customer at the self-checkout, or it goes to an associate monitoring the scan and go/self-checkout lanes. In another example, the notification is transmitted to a user device associated with a user performing a receipt check at an exit door.

In still other examples, if an unscanned item is detected, the notification is transmitted to a SCO or other checkout device. The notification instructs the customer to wait for an associate to assist the customer at the SCO. The associate optionally also receives a notification instructing the associated to assist the customer with scanning the missed items. For example, the SCO may display a notification that says, “wait for associate to assist you” or “scanning error.” This notification prevents the SCO transaction from completing until the associate enters a code or otherwise assists the user with scanning the missed items or removing the removing undesired items which were unscanned.

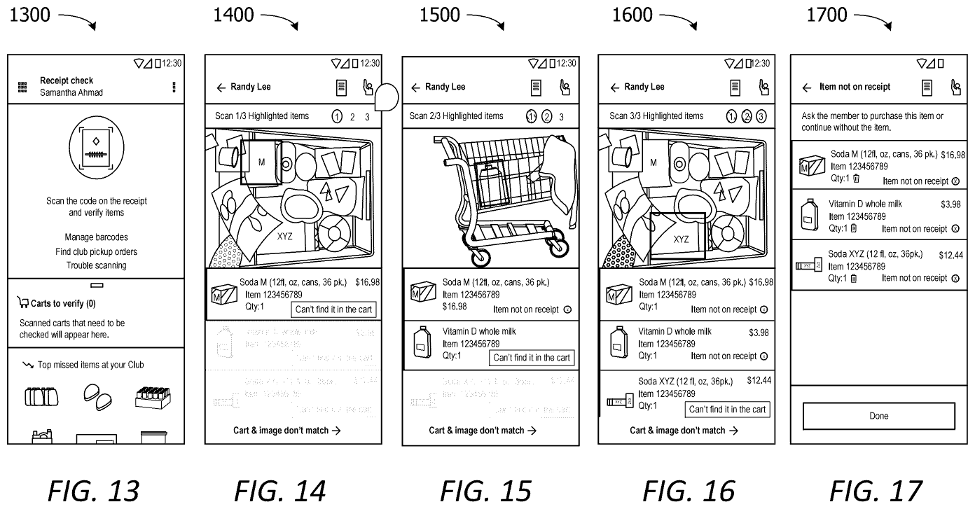

FIG. 13, FIG. 14, FIG. 15, FIG. 16, and FIG. 17 include exemplary set screenshots of a set of notifications displayed via a UI associated with a checkout device, such as a staffed or unstaffed checkout. The notifications in this example display a list of the unscanned items, an image of the selected cart having the unscanned items highlighted by bounding boxes and/or an anchor image of each item is presented with the name, brand, variety, and other descriptive information associated with each unpaid item.

FIG. 13 is an exemplary screenshot 1300 showing a receipt check screen displayed via a UI device. The receipt check screen is displayed to a user performing a receipt check at exit. During receipt check, an authorized user determines whether the items in a shopping cart matches the list of items in the receipt that is matched to the cart by the basket matching process.

FIG. 14 is an exemplary screenshot 1400 of a scan items notification including a cart image with instructions to scan a sample of the items in the cart associated with the image. The notification includes instructions to scan highlighted items in the annotated cart image. The notification is presented to a user performing the receipt check via a user device, such as a tablet.

FIG. 15 is an exemplary screenshot 1500 of a scan items notification including a cart image with a side view of a cart. The notification is presented to a user performing the receipt check via a user device, such as a tablet.

FIG. 16 is an exemplary screenshot 1600 of a scan items notification including a cart image with highlighted items for scanning by a user prior to customer exit. The notification is presented to a user performing the receipt check via a user device, such as a tablet. In this example, the user is instructed to scan items in the cart to ensure the items in the cart are included on the receipt matched to the cart.

FIG. 17 is an exemplary screenshot 1700 of an unscanned items notification displayed via a UI device. The notification is presented to a user performing the receipt check via a user device, such as a tablet. In this example, one or more items in the cart fails to appear on the receipt matched to the cart. These unscanned items should be scanned and paid for or removed from the cart prior to the customer exiting the store or other retail facility with the cart.

### Additional Examples

In some examples, the frontend CV pipeline includes five computer vision models, including a cart detection model, item detection model, two item recognition model, and/or a depth detection model. The cart detection model uses 5-20 images captured by the camera at the staffed checkout lane. A cart detection algorithm is employed to isolate and extract the cart and belt area within the staffed checkout zone. Additionally, a depth model estimates the depth value of each cart in the view, enabling the system to accurately identify the cart corresponding to the ongoing transaction. An item detection model crops images of items present in the cart or on the belt. This process enables precise localization of items within the captured images. Two item recognition algorithms are utilized to infer the UPC from the cropped item images. These algorithms facilitate accurate identification and recognition of items in the transaction. By leveraging the aforementioned computer vision models, the frontend CV system generates an item list by inferring from the 5-20 transaction images. This item list is then compared with the e-receipt item list, resulting in the prediction of two lists: the paid item list (checked items that have been paid for) and the unpaid item list (potential shrinkage items). In the event that the frontend CV system detects unpaid items during a transaction, upon receiving the ‘ready to pay’ signal, it sends notifications to the tablet mounted next to the checkout monitor. These notifications display red bounding boxes, one at a time, on the checkout image, effectively highlighting the unpaid items for further attention and resolution.

In some embodiments, the frontend CV system effectively verifies the presence of unpaid items during an ongoing transaction, eliminating the need for an additional random check by the exit greeter at the exit door. This streamlined process significantly reduces friction for members, ensuring a seamless and frictionless exit experience, especially for ‘green to go’ transactions. Paying for unpaid items upstream at the POS is considerably more convenient than doing so at the exit door. With the frontend CV system, any unpaid item can be easily repaid at the POS, whereas attempting to make repayment at the exit door poses challenges and potential embarrassment to the members.

Other embodiments provide a system to recognize and identify items that are likely to have been missed during a checkout process at a POS. The system includes multiple computer vision image capture models for identifying the cart associated with the current transaction. The system identifies items in the cart and on the conveyor belt or other region associated with the current transaction by applying an item detection algorithm to crop images of items. The system recognizes the identified items and infers item codes (UPCs). The system compares the identified items with a receipt of the transaction. The system sends notifications to the POS/cashier including information about possible missed items right before the transaction is completed. The system completes payment or repayment of the identified missed items before the transaction is completed. The system reduces the occurrence of item shrink and the need for manual receipt checking at the exit of the store.

In other embodiments, the system performs item scan verification based on the information of the images and item scan information. The system verifies the items that have already been scanned via item recognition and verification. At the end, when the user clicks the finish (ready to pay) button, the system provides a recommendation for unpaid/unscanned items which are recognized in the image data but not identified in the scan data and/or on the receipt. The system gives the customer an opportunity to scan the missed items before completing the transaction and/or leaving the checkout lane.

In some examples, two cameras are installed at two different locations, such as at the ceiling and at the bottom of the counter near expected cart locations. The cameras capture different angles of transaction cart and conveyor at transaction time used to correlate transaction scanned items with recognized items in cart and/or on the conveyor.

In other embodiments, the items are scanned and mapping recognized items to the scanned items occurs in parallel for reduced latency and improved processing efficiency. This further enables faster result generation with reduced error rate as scanned items are verified against image data object detection results. In this manner, the system provides zero-friction exit experience for staffed lane members via frontend computer vision.

The system applies grouping logic in some embodiments in which an item fails to be accurately identified by the item recognition algorithm. In such cases, if an exact match for an item is not found, the system may infer a group of item IDs for similar items. For example, grouping logic can be applied to map an item identified as a twenty-four pack soft drink of brand A to a scanned item for a thirty-six pack soft drink of the same brand A. In this case, although the system failed to exactly identify the item, the system is able to map the identified item to any item in a group of items having the same brand and/or category of items.

Alternatively, or in addition to the other examples described herein, examples include any combination of the following:
isolate the selected cart and a conveyor belt in an image;
extract a cropped image of the selected cart and the conveyor belt area within a staffed checkout area;
obtain a plurality of images comprising a plurality of carts; track the selected cart through the plurality of images; and place a bounding box around the selected cart in each image in the plurality of images;
estimates a depth value of each cart in a plurality of carts within the image; and identify the cart selected corresponding to the current transaction;
add a set of indicators to the set of unscanned item images, wherein the set of indicators comprises a bounding box associated with each unscanned item in at least one image;
display an image of each unscanned item in the set of unscanned items on the UI device one at a time, wherein the user is instructed to scan each item as it is displayed on the UI, wherein an image of a first unscanned item is displayed with a first instruction to scan the first unscanned item;
upon receiving scan data for a first unscanned item, display an image of a second unscanned item with a second instruction to scan the second unscanned item;
a set of cameras, the set of cameras comprising a ceiling mounted camera capturing a set of images associated with a top view of the selected cart and a camera mounted to a portion of the POS device capturing a set of images associated with a side view of the selected cart, wherein the set of cameras transmits a plurality of images of the selected cart to a computing device via a network;
obtaining an image of a selected cart and a plurality of items associated with the selected cart;
identifying the plurality of items associated with the selected cart;
predicting an item identifier (ID) associated with each item in the plurality of items, wherein a set of identified items comprising a plurality of item IDs associated with the plurality of items is generated;
obtaining item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device;
mapping each scanned item ID to an identified item ID in the set of identified items;
upon receiving a scan complete signal from the POS device indicating a user is ready to pay for the set of scanned items, identifying a set of unscanned item based on mapping of the set of identified items to the set of scanned items, wherein an unscanned item is an item having an item ID in the set of identified items that fails to map to a corresponding item ID in the set of scanned items;
sending a notification to a user interface device associated with the POS device prior to completion of the current transaction, the notification comprising the set of unscanned items and a set of unscanned item images, wherein a user is instructed to scan each item in the set of unscanned items;
receiving first scan data associated with a first scanned item from the POS device, the first scan data comprising a first scanned item ID;
adding the first scanned item ID to the set of scanned items;
receiving second scan data associated with a second scanned item from the POS device, the second scan data comprising a second scanned item ID;
adding the second scanned item ID to the set of scanned items in real-time prior to receiving a payment associated with completion of the current transaction;
obtaining a plurality of images comprising a plurality of carts;
tracking the selected cart through the plurality of images;
placing a bounding box around the selected cart in each image in the plurality of images;
cropping each image to isolate the selected cart from other objects based on the bounding box around the selected cart in each image;
estimating, by a depth model, a depth value of each cart in a plurality of carts within the image; and identifying the cart selected corresponding to the current transaction based on the depth value, wherein the depth value indicates a proximity of the selected cart to the POS device;
displaying an image of each unscanned item in the set of unscanned items on the UI device one at a time, wherein the user is instructed to scan each item as it is displayed on the UI, wherein an image of a first unscanned item is displayed with a first instruction to scan the first unscanned item;
upon receiving scan data for a first unscanned item, displaying an image of a second unscanned item with a second instruction to scan the second unscanned item;
identifying each item on a conveyor belt associated with the POS device based on a top view image of the conveyor belt;
predicting an item ID associated with each item on the conveyor belt;
adding the item ID associated with each item on the conveyor belt to the set of identified items;
generating a plurality of images of the selected cart by a set of cameras, the set of cameras comprising a ceiling mounted camera capturing a set of images associated with a top view of the selected cart, the set of cameras further comprising a camera mounted to a portion of the POS device capturing a set of images associated with a side view of the selected cart, wherein the set of cameras transmits a plurality of images of the selected cart to a computing device via a network;
obtain an image of a selected cart and a conveyor belt associated with a POS device, the image comprising a plurality of items associated with the selected cart and the conveyor belt;
identify the plurality of items associated with the selected cart and the conveyor belt;
predict an item identifier (ID) associated with each item in the plurality of items, wherein a set of identified items comprising a plurality of item IDs associated with the plurality of items is generated;
obtain item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device;
map each scanned item ID to an identified item ID in the set of identified items;
upon receiving a scan complete signal from the POS device indicating a user is ready to pay for the set of scanned items, identify a set of unscanned item based on mapping of the set of identified items to the set of scanned items, wherein an unscanned item is an item having an item ID in the set of identified items that fails to map to a corresponding item ID in the set of scanned items;
send a notification to a user interface device associated with the POS device prior to completion of the current transaction, the notification comprising the set of unscanned items and a set of unscanned item images, wherein a user is instructed to scan each item in the set of unscanned items;
display an image of the selected cart including a set of indicators associated with the set of unscanned items;
display an image of each unscanned item in the set of unscanned items on the UI device one at a time, wherein the user is instructed to scan each item as it is displayed on the UI, wherein an image of a first unscanned item is displayed with a first instruction to scan the first unscanned item;
estimate, by a depth model, a plurality of depth values associated with a plurality of carts within an image;
select a cart closest to the POS device based on the plurality of depth values, wherein the depth value indicates a proximity of the selected cart to the POS device;
wherein the item ID is a universal product code (UPC);
wherein the POS device is associated with a staffed checkout lane; and
wherein the POS device is associated with an unstaffed self-checkout (SCO) lane.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 4, FIG. 5, and FIG. 6.

In some examples, the operations illustrated in FIG. 4, FIG. 5, and FIG. 6 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of frontend unscanned item identification, the method comprising obtaining an image of a selected cart and a plurality of items associated with the selected cart; identifying the plurality of items associated with the selected cart; predicting an item identifier (ID) associated with each item in the plurality of items, wherein a set of identified items comprising a plurality of item IDs associated with the plurality of items is generated; obtaining item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device; mapping each scanned item ID to an identified item ID in the set of identified items; upon receiving a scan complete signal from the POS device indicating a user is ready to pay for the set of scanned items, identifying a set of unscanned item based on mapping of the set of identified items to the set of scanned items, wherein an unscanned item is an item having an item ID in the set of identified items that fails to map to a corresponding item ID in the set of scanned items; and sending a notification to a user interface device associated with the POS device prior to completion of the current transaction, the notification comprising the set of unscanned items and a set of unscanned item images, wherein a user is instructed to scan each item in the set of unscanned items.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for frontend identification of unscanned items. For example, the elements illustrated in FIG. 1, FIG. 2, and FIG. 3, such as when encoded to perform the operations illustrated in FIG. 4, FIG. 5, and FIG. 6, constitute exemplary means for obtaining an image of a selected cart and a plurality of items associated with the selected cart; exemplary means for identifying the plurality of items associated with the selected cart; exemplary means for predict an item identifier (ID) associated with each item in the plurality of items; exemplary means for obtaining item scan data in real time from a point-of-sale (POS) device; exemplary means for mapping each scanned item ID to an identified item ID in the set of identified items; exemplary means for identifying a set of unscanned item based on mapping of the set of identified items to the set of scanned items, wherein an unscanned item is an item having an item ID in the set of identified items that fails to map to a corresponding item ID in the set of scanned items; and exemplary means for sending a notification to a user interface device associated with the POS device prior to completion of the current transaction, the notification comprising the set of unscanned items and a set of unscanned item images, wherein a user is instructed to scan each item in the set of unscanned items.

Other non-limiting examples provide one or more computer storage devices having a first computer-executable instructions stored thereon for providing frontend identification of unscanned items. When executed by a computer, the computer performs operations including obtaining an image of a selected cart and a plurality of items associated with the selected cart; identifying the plurality of items associated with the selected cart; predicting an item identifier (ID) associated with each item in the plurality of items, wherein a set of identified items comprising a plurality of item IDs associated with the plurality of items is generated; obtaining item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device; mapping each scanned item ID to an identified item ID in the set of identified items; upon receiving a scan complete signal from the POS device indicating a user is ready to pay for the set of scanned items, identifying a set of unscanned item based on mapping of the set of identified items to the set of scanned items, wherein an unscanned item is an item having an item ID in the set of identified items that fails to map to a corresponding item ID in the set of scanned items; and sending a notification to a user interface device associated with the POS device prior to completion of the current transaction, the notification comprising the set of unscanned items and a set of unscanned item images, wherein a user is instructed to scan each item in the set of unscanned items.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for frontend unscanned item identification, the system comprising:
a processor; and
a computer-readable medium storing instructions that are operative upon execution by the processor to:
obtain an image of a selected cart and a plurality of items associated with the selected cart;
identify the plurality of items associated with the selected cart;
predict an item identifier (ID) associated with each item in the plurality of items, wherein a set of identified items comprising a plurality of item IDs associated with the plurality of items is generated;
obtain item scan data in real time from a point-of-sale (POS) device, the item scan data comprising an item ID associated with each item scanned at the POS device during a current transaction, wherein a set of scanned items comprises an ID for each scanned item associated with the item scan data received from the POS device;
map each scanned item ID to an identified item ID in the set of identified items;
upon receiving a scan complete signal from the POS device indicating a user is ready to pay for the set of scanned items, identify a set of unscanned items based on mapping of the set of identified items to the set of scanned items, wherein an unscanned item is an item in the set of identified items that fails to map to a corresponding item ID in the set of scanned items; and
send a notification to a user interface device associated with the POS device prior to completion of the current transaction, the notification comprising the set of unscanned items and a set of unscanned item images, wherein the user is instructed to scan each item in the set of unscanned items.

2. The system of claim 1, wherein the instructions are further operative to:
isolate the selected cart and a conveyor belt in an image; and
extract a cropped image of the selected cart and a conveyor belt area within a staffed checkout area.

3. The system of claim 1, wherein the instructions are further operative to:
obtain a plurality of images comprising a plurality of carts;
track the selected cart through the plurality of images; and
place a bounding box around the selected cart in each image in the plurality of images.

4. The system of claim 1, wherein the instructions are further operative to:
estimates a depth value of each cart in a plurality of carts within the image; and
identify the selected cart corresponding to the current transaction.

5. The system of claim 1, wherein the instructions are further operative to:
add a set of indicators to the set of unscanned item images, wherein the set of indicators comprises a bounding box associated with each unscanned item in at least one image.

6. The system of claim 1, wherein the instructions are further operative to:
display an image of each unscanned item in the set of unscanned items on a user interface (UI) device one at a time, wherein the user is instructed to scan each item as it is displayed on the UI device, wherein a first image of a first unscanned item is displayed with a first instruction to scan the first unscanned item; and
upon receiving scan data for the first unscanned item, display a second image of a second unscanned item with a second instruction to scan the second unscanned item.

7. The system of claim 1 further comprising:
a set of cameras, the set of cameras comprising a ceiling mounted camera capturing a first set of images associated with a top view of the selected cart and a camera mounted to a portion of the POS device capturing a second set of images associated with a side view of the selected cart, wherein the set of cameras transmits a plurality of images of the selected cart to a computing device via a network.

8. A method for frontend unscanned item detection, the method comprising:
obtaining an image of a selected cart and a plurality of items associated with the selected cart;
identifying the plurality of items associated with the selected cart;
predicting an item identifier (ID) associated with each item in the plurality of items, wherein a set of identified items comprising a plurality of item IDs associated with the plurality of items is generated;
obtaining item scan data in real time from a point-of-sale (POS) device, the item scan data comprising an item ID associated with each item scanned at the POS device during a current transaction, wherein a set of scanned items comprises an item ID for each scanned item associated with the item scan data received from the POS device;
mapping each scanned item ID to an identified item ID in the set of identified items;
upon receiving a scan complete signal from the POS device indicating a user is ready to pay for the set of scanned items, identifying a set of unscanned items based on mapping of the set of identified items to the set of scanned items, wherein an unscanned item is an item in the set of identified items that fails to map to a corresponding item ID in the set of scanned items; and
sending a notification to a user interface device associated with the POS device prior to completion of the current transaction, the notification comprising the set of unscanned items and a set of unscanned item images, wherein the user is instructed to scan each item in the set of unscanned items.

9. The method of claim 8, further comprising:
receiving first scan data associated with a first scanned item from the POS device, the first scan data comprising a first scanned item ID;
adding the first scanned item ID to the set of scanned items;
receiving second scan data associated with a second scanned item from the POS device, the second scan data comprising a second scanned item ID; and
adding the second scanned item ID to the set of scanned items in real-time prior to receiving a payment associated with completion of the current transaction.

10. The method of claim 8, further comprising:
obtaining a plurality of images comprising a plurality of carts;
tracking the selected cart through the plurality of images;
placing a bounding box around the selected cart in each image in the plurality of images; and
cropping each image to isolate the selected cart from other objects based on the bounding box around the selected cart in each image.

11. The method of claim 8, further comprising:
estimating, by a depth model, a depth value of each cart in a plurality of carts within the image; and
identifying the selected cart corresponding to the current transaction based on the depth value, wherein the depth value indicates a proximity of the selected cart to the POS device.

12. The method of claim 8, further comprising:
displaying an image of each unscanned item in the set of unscanned items on a UI device one at a time, wherein the user is instructed to scan each item as it is displayed on the UI, wherein a first image of a first unscanned item is displayed with a first instruction to scan the first unscanned item; and
upon receiving scan data for a first unscanned item, displaying a second image of a second unscanned item with a second instruction to scan the second unscanned item.

13. The method of claim 8, further comprising:
identifying each item on a conveyor belt associated with the POS device based on a top view image of the conveyor belt;
predicting an item ID associated with each item on the conveyor belt; and
adding the item ID associated with each item on the conveyor belt to the set of identified items.

14. The method of claim 8, further comprising:
generating a plurality of images of the selected cart by a set of cameras, the set of cameras comprising a ceiling mounted camera capturing a first set of images associated with a top view of the selected cart, the set of cameras further comprising a camera mounted to a portion of the POS device capturing a second set of images associated with a side view of the selected cart, wherein the set of cameras transmits a plurality of images of the selected cart to a computing device via a network.

15. One or more computer storage devices having computer-executable instructions stored thereon, which, upon execution by a computer, cause the computer to perform operations comprising:
obtain an image of a selected cart and a conveyor belt associated with a POS device, the image comprising a plurality of items associated with the selected cart and the conveyor belt;
identify the plurality of items associated with the selected cart and the conveyor belt;
predict an item identifier (ID) associated with each item in the plurality of items, wherein a set of identified items comprising a plurality of item IDs associated with the plurality of items is generated;
obtain item scan data in real time from a point-of-sale (POS) device, the item scan data comprising an item ID associated with each item scanned at the POS device during a current transaction, wherein a set of scanned items comprises an ID for each scanned item associated with the item scan data received from the POS device;
map each scanned item ID to an identified item ID in the set of identified items;
upon receiving a scan complete signal from the POS device indicating a user is ready to pay for the set of scanned items, identify a set of unscanned items based on mapping of the set of identified items to the set of scanned items, wherein an unscanned item is an item in the set of identified items that fails to map to a corresponding item ID in the set of scanned items; and
send a notification to a user interface device associated with the POS device prior to completion of the current transaction, the notification comprising the set of unscanned items and a set of unscanned item images, wherein the user is instructed to scan each item in the set of unscanned items.

16. The one or more computer storage devices of claim 15, wherein the operations further comprise:
display a first image of the selected cart including a set of indicators associated with the set of unscanned items; and
display an image of each unscanned item in the set of unscanned items on a UI device one at a time, wherein the user is instructed to scan each item as it is displayed on the UI, wherein a second image of a first unscanned item is displayed with a first instruction to scan the first unscanned item.

17. The one or more computer storage devices of claim 15, wherein the operations further comprise:
estimate, by a depth model, a plurality of depth values associated with a plurality of carts within an image; and
select a cart closest to the POS device based on the plurality of depth values, wherein the depth value indicates a proximity of the selected cart to the POS device.

18. The one or more computer storage devices of claim 15, wherein the item ID is a universal product code (UPC).

19. The one or more computer storage devices of claim 15, wherein the POS device is associated with a staffed checkout lane.

20. The one or more computer storage devices of claim 15, wherein the POS device is associated with an unstaffed self-checkout (SCO) lane.
